(19) United States
(12) Patent Application Publication
(10) Pub. No.: US 2019/0013171 A1
(43) Pub. Date: Jan. 10, 2019

(54) CONTACT MECHANISM AND ELECTROMAGNETIC RELAY

(71) Applicant: OMRON Corporation, Kyoto (JP)

(72) Inventors: Ryota Minowa, Kumamoto (JP); Shingo Mori, Kumamoto (JP)

(73) Assignee: OMRON Corporation, Kyoto (JP)

(21) Appl. No.: 16/131,836

(22) Filed: Sep. 14, 2018

Related U.S. Application Data
(63) Continuation of application No. PCT/JP2017/005366, filed on Feb. 14, 2017.

(30) Foreign Application Priority Data
Apr. 22, 2016 (JP) 2016-086450

(51) Int. Cl. H01H 50/54; H01H 50/44

(52) U.S. Cl. CPC H01H 50/546; H01H 50/44

(57) ABSTRACT

A contact mechanism includes a first fixed contact, a second fixed contact, a first movable contact that faces the first fixed contact, and that is disposed so as to come into contact with or be separated from the first fixed contact, and a second movable contact that faces the second fixed contact, and that is disposed so as to come into contact with or be separated from the second fixed contact. The first fixed contact and the first movable contact are disposed so as to face each other in a direction intersecting with a contact-separation direction in which the first movable contact and the second movable contact come into contact with or are separated from the first fixed contact and the second fixed contact. The second fixed contact and the second movable contact are disposed so as to face each other in the direction intersecting with the contact-separation direction.

### BACKGROUND

### Technical Field

The present invention relates to a contact mechanism and an electromagnetic relay including the same.

### Related Art

The electromagnetic relay disclosed in Patent Document 1 includes a pair of fixed contacts, a pair of movable contacts that respectively come into contact with or are separated from the pair of fixed contacts, and a movable touch piece that couples the pair of movable contacts, and an auxiliary yoke is provided between the pair of fixed contacts and the pair of movable contacts.

In the electromagnetic relay, an electromagnetic repulsive force is canceled out by the attraction force of the auxiliary yoke to ensure the contact reliability between the contacts, the electromagnetic repulsive force being generated when a current flows by conduction between the contacts.

### PATENT DOCUMENT

Patent Document 1: Japanese Patent No. 5559662

### SUMMARY OF THE INVENTION

One or more embodiments of the present invention is capable of ensuring the contact reliability between contacts which is not disclosed in conventional electromagnetic relays including Patent Document 1.

A contact mechanism and an electromagnetic relay according to one or more embodiments of the present invention is capable of ensuring the contact reliability between contacts.

A contact mechanism according to one or more embodiments of the present invention includes: a first fixed contact and a second fixed contact; and a first movable contact and a second movable contact that respectively face the first fixed contact and the second fixed contact, and are disposed so as to respectively come into contact with or be separated from the first fixed contact and the second fixed contact. The first fixed contact and the first movable contact are disposed so as to face each other in a direction intersecting with a contact or separation direction in which the first movable contact and the second movable contact come into contact with or are separated from the first fixed contact and the second fixed contact. The second fixed contact and the second movable contact are disposed so as to face each other in the direction intersecting with the contact or separation direction.

Further, an electromagnetic relay according to one or more embodiments of the present invention includes the contact mechanism.

According to one or more embodiments of the present invention, when the fixed contact and the movable contact come into contact with each other and are energized, an electromagnetic repulsive force is generated in the direction intersecting with the direction in which the fixed contact and the movable contact come into contact or are separated. Therefore, the electromagnetic repulsive force acting in the direction in which the fixed contact and the movable contact are separated is reduced, and the contact reliability between the fixed contact and the movable contact can be ensured.

Further, a contact mechanism according to one or more embodiments of the present invention ensures contact reliability between the fixed contact and the movable contact.

### BRIEF DESCRIPTION OF THE DRAWINGS

FIG. 1 is a perspective view of an electromagnetic relay provided with a contact mechanism of one or more embodiments of the present invention.

FIG. 2 is a sectional view taken along line II-II of FIG. 1.

FIG. 3 is a perspective view of a contact mechanism portion in the electromagnetic relay of FIG. 1.

FIG. 4 is a front view illustrating an open state of the contact mechanism portion of FIG. 3.

FIG. 5 is a front view illustrating a closed state of the contact mechanism portion of FIG. 3.

FIG. 6 is a perspective view illustrating a first modification of the contact mechanism portion in the electromagnetic relay of FIG. 1.

FIG. 7 is a front view illustrating the open state of the contact mechanism portion of FIG. 6.

FIG. 8 is a front view illustrating the closed state of the contact mechanism portion of FIG. 6.

FIG. 9 is a perspective view illustrating a second modification of the contact mechanism portion in the electromagnetic relay of FIG. 1.

FIG. 10 is a front view illustrating the open state of the contact mechanism portion of FIG. 9.

FIG. 11 is a front view illustrating the closed state of the contact mechanism portion of FIG. 9.

FIG. 12 is a perspective view illustrating a third modification of the contact mechanism portion in the electromagnetic relay of FIG. 1.

FIG. 13 is a front view illustrating the open state of the contact mechanism portion of FIG. 12.

FIG. 14 is a front view illustrating the closed state of the contact mechanism portion of FIG. 12.

FIG. 15 is a perspective view illustrating a fourth modification of the contact mechanism portion in the electromagnetic relay of FIG. 1.

FIG. 16 is a front view illustrating the open state of the contact mechanism portion of FIG. 15.

FIG. 17 is a front view illustrating the closed state of the contact mechanism portion of FIG. 15.

FIG. 18 is a perspective view illustrating the fourth modification of the contact mechanism portion in the electromagnetic relay of FIG. 1.

FIG. 19 is a front view illustrating the open state of the contact mechanism portion of FIG. 18.

FIG. 20 is a front view illustrating the closed state of the contact mechanism portion of FIG. 18.

FIG. 21 is a perspective view illustrating a fifth modification of the contact mechanism portion in the electromagnetic relay of FIG. 1.

FIG. 22 is a front view illustrating the open state of the contact mechanism portion of FIG. 21.

FIG. 23 is a front view illustrating the closed state of the contact mechanism portion of FIG. 21.

### DETAILED DESCRIPTION

Hereinafter, embodiments of the present invention will be described with reference to the accompanying drawings. In the following description, terms (e.g., terms including “upper”, “lower”, “right”, and “left”) indicating specific directions or positions are used as necessary, but the use of these terms is for facilitating understanding of the invention with reference to the drawings, and the technical scope of the present invention is not limited by the meaning of these terms. The following description is merely exemplary in nature and is not intended to limit the invention, its application, or its usage. Further, the drawings are schematic, and ratios of dimensions do not necessarily agree with actual ones. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

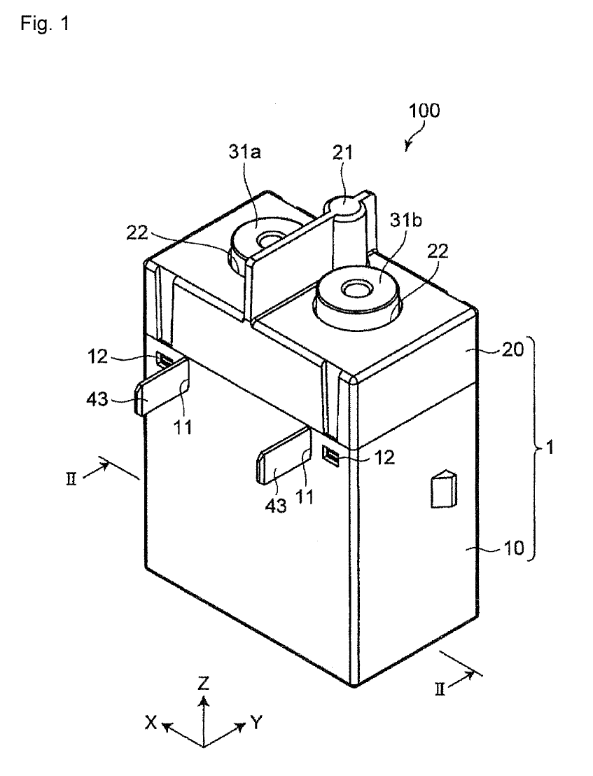

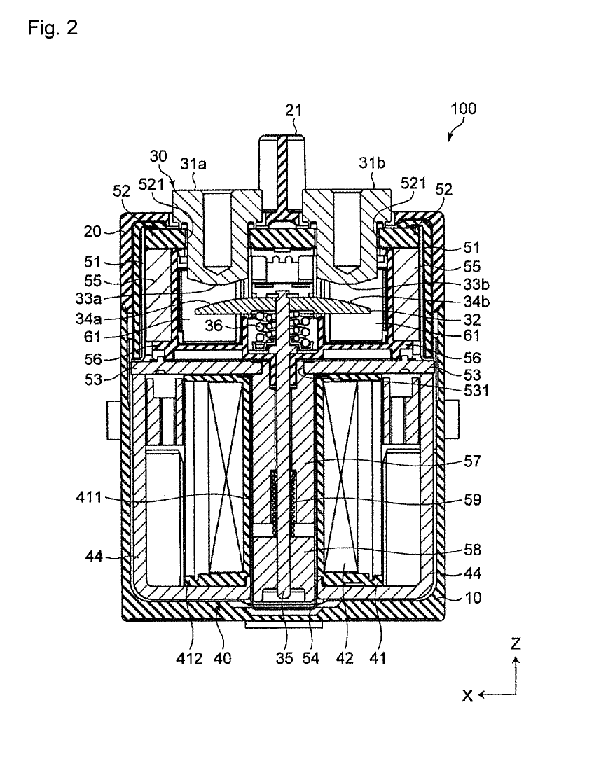

As illustrated in FIG. 1, an electromagnetic relay 100 according to one or more embodiments of the present invention includes a housing 1 made up of a case 10 and a cover 20. As illustrated in FIG. 2, a contact mechanism portion 30 and an electromagnet portion 40 that drives the contact mechanism portion 30 are accommodated inside the housing 1.

In FIG. 2, a horizontal direction is defined as an X direction, and a vertical direction is defined as a Z direction. Further, a direction orthogonal to the X and Z directions is defined as a Y direction.

As illustrated in FIG. 1, the case 10 has a rectangular box shape. As illustrated in FIG. 2, the case 10 has an opening on the upper side in the Z direction, and is formed so as to be able to accommodate on the inside a part of the contact mechanism portion 30 and the electromagnet portion 40.

As illustrated in FIG. 1, the side surface of the case 10 in the Y direction is provided with a terminal groove 11 in which a coil terminal 43 protrudes, and a latching hole 12 for fixing the case 10 and the cover 20.

As illustrated in FIG. 1, the cover 20 has a rectangular box shape and is attached so as to cover the opening of the case 10. As illustrated in FIG. 2, the cover 20 has an opening at the lower side in the Z direction, and is formed so as to be able to accommodate a part of the contact mechanism portion 30 inside the opening.

The upper surface of the cover 20 in the Z direction is provided with a partition wall 21 which is provided substantially at the center in the X direction and extends in the Y direction. Terminal holes 22, in which fixed terminals 31a, 31b protrude, are respectively provided on both sides of the partition wall 21 in the X direction. Although not illustrated, the opening of the cover 20 is provided with latching pawls for fixing the case 10 and the cover 20 together with the latching holes 12 of the case 10.

As illustrated in FIG. 2, the contact mechanism portion 30 includes a first fixed terminal 31a and a second fixed terminal 31b disposed at an interval along the X direction, and a movable touch piece 32 disposed so as to face the first fixed terminal 31a and the second fixed terminal 31b.

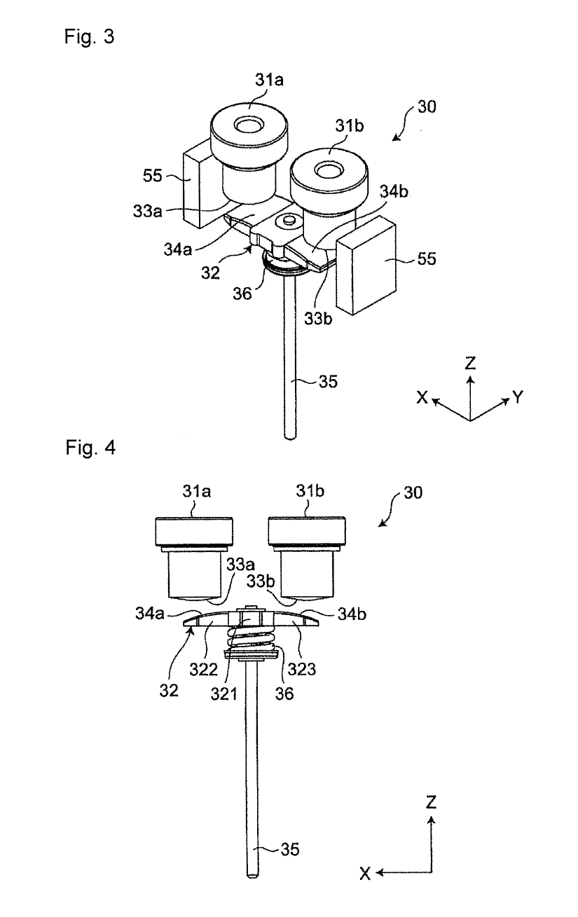

Each of the first fixed terminal 31a and the second fixed terminal 31b has a substantially cylindrical shape as illustrated in FIG. 3. As illustrated in FIG. 4, the respectively lower end faces of the first fixed terminal 31a and the second fixed terminal 31b in the Z direction are provided with a first fixed contact 33a and a second fixed contact 33b each having a substantially flat inclined surface inclined downward from the peripheral edge in the Z direction. Each of the first fixed contact 33a and the second fixed contact 33b has a substantially circular shape in a planar view seen along the Z direction.

As illustrated in FIG. 4, the movable touch piece 32 is made up of a center portion 321 in which a movable shaft 35 is provided, and a first contact portion 322 and a second contact portion 323 which extend along the X direction from both sides of the center portion 321 in the X direction. The first contact portion 322 has a convex curved surface on the upper side in the Z direction. The convex curved surface of the first contact portion 322 is curved downward in the Z direction toward the left side in the X direction and is disposed so as to be able to come into contact with the first fixed contact 33a. The convex curved surface of the first contact portion 322 also serves as a first movable contact 34a. That is, the first movable contact 34a has a convex curved surface that can come into contact with the first fixed contact 33a. The second contact portion 323 has a convex curved surface on the upper side in the Z direction. The convex curved surface of the second contact portion 323 is curved downward in the Z direction toward the right side in the X direction and is disposed so as to be able to come into contact with the second fixed contact 33b. The convex curved surface of the second contact portion 323 also serves as a second movable contact 34b. That is, the second movable contact 34b has a convex curved surface that can come into contact with the second fixed contact 33b. Note that the convex curved surface of each of the movable contacts 34a, 34b may be a two-dimensional convex curved surface or a three-dimensional convex curved surface (e.g., spherical surface).

The first movable contact 34a and the second movable contact 34b are disposed so as to face the first fixed contact 33a and the second fixed contact 33b, respectively and are electrically connected to each other by the movable touch piece 32. In addition, each of the first movable contact 34a and the second movable contact 34b comes into contact or is separated from each of the first fixed contact 33a and the second fixed contact 33b by reciprocation of the movable touch piece 32 in the Z direction. The movable shaft 35 is provided substantially at the center of the movable touch piece 32 and extends downward in the Z direction.

The first fixed terminal 31a and the first movable contact 34a are disposed symmetrically with respect to the movable shaft 35, and the second fixed terminal 31b and the second movable contact 34b are disposed symmetrical with respect to the movable shaft 35.

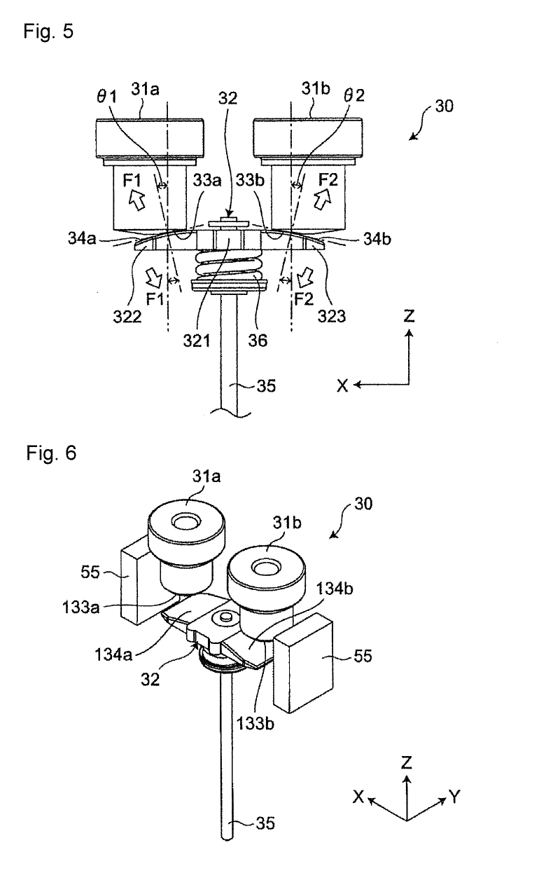

Further, as illustrated in FIG. 5, a direction forming an angle of 01 with respect to a contact or separation direction (Z direction) in which the first movable contact 34a comes into contact with or is separated from the first fixed contact 33a is a direction in which the first fixed contact 33a and the first movable contact 34a face each other. Meanwhile, a direction forming an angle of θ2 with respect to the Z direction is a direction in which the second fixed contact 33b and the second movable contact 34b face each other. That is, the first fixed contact 33a and the first movable contact 34a are disposed such that the contact surfaces thereof face each other in the direction intersecting with the Z direction (contact or separation direction), and the second fixed contact 33b and the second movable contact 34b are disposed such that the contact surfaces thereof face each other in the direction intersecting with the Z direction.

As illustrated in FIG. 2, a flange 51 having a tubular shape, a ceramic plate 52, a first yoke 53 having a platy shape, and a bottomed cylindrical body 54 are provided inside the housing 1. The flange 51 and the ceramic plate 52 are disposed inside the cover 20, and the first yoke 53 and the bottomed cylindrical body 54 are disposed inside the case 10.

The flange 51 has openings above and below in the Z direction.

The ceramic plate 52 is disposed so as to close the upper opening of the flange 51 in the Z direction. The ceramic plate 52 is provided with terminal holes 521. The fixed terminals 31a, 31b are inserted and brazed into the terminal holes 521.

The first yoke 53 is disposed so as to close the lower opening of the flange 51 in the Z direction. An opening 531 is provided in the center portion of the first yoke 53. The movable shaft 35 is inserted into the opening 531.

The bottomed cylindrical body 54 extends from the first yoke 53 to the bottom of the case 10 and is disposed so as to cover the opening 531 of the first yoke 53. The bottomed cylindrical body 54 accommodates on the inside the movable shaft 35, a fixed iron core 57 fixed to the first yoke 53, and a movable iron core 58 fixed to the tip (the lower end in the Z direction) of the movable shaft 35. A return spring 59 is provided between the fixed iron core 57 and the movable iron core 58.

The flange 51, the ceramic plate 52, and the first yoke 53 are integrated, and the first yoke 53 and the bottomed cylindrical body 54 are joined hermetically. As a result, a sealed space is formed inside the flange 51, the ceramic plate 52, the first yoke 53, and the bottomed cylindrical body 54. The first and second fixed contacts 33a, 33b and the first and second movable contacts 34a, 34b are disposed in the sealed space.

A pair of permanent magnets 55, 55 and an arc shielding member 61 are provided in the sealed space inside the flange 51.

The pair of permanent magnets 55, 55 face each other and are disposed at both ends in the X direction in the inside the flange 51 so as to sandwich the pair of fixed contacts 33a, 33b and the pair of movable contacts 34a, 34b. The pair of permanent magnets 55, 55 are held by a magnet holder 56 made of an insulating material. The magnet holder 56 extends to the movable shaft 35 along the upper surface of the first yoke 53 in the Z direction. A spring tray 37 held by the movable shaft 35 and a coil spring 35 disposed between the spring tray 37 and the movable touch piece 32 are provided between the magnet holder 56 and the movable touch piece 32. The movable shaft 35 is disposed inside the coil spring 35.

The arc shielding member 61 is disposed so as to cover both sides in the Y direction (the back side and the front side in FIG. 2) of the pair of fixed contacts 33a, 33b and the pair of movable contacts 34a, 34b and the outside (the sides closer to the adjacent permanent magnets 55) thereof in the X direction. A space (not illustrated) for causing the magnetic flux of the permanent magnet 55 to pass therethrough is formed outside the arc shielding member 61 in the X direction.

As illustrated in FIG. 2, the electromagnet portion 40 is made up of a spool 41, a coil 42 wound around the spool 41, and the coil terminal 43 (illustrated in FIG. 1) fixed to the spool 41.

The spool 41 includes on the inside a body portion 411 in which the bottomed cylindrical body 54 is disposed, and guard portions 412 provided on both ends of the body 411. The spool 41 is disposed so as to be in contact with the lower surface of the first yoke 53 in the Z direction. The coil 42 is wound around the body portion 411, and the coil terminal 43 is fixed to the upper guard portion 412 in the Z direction. Note that the coil 42 is directly wound around the coil terminal 43 without interposing a lead wire.

Inside the housing 1, a second yoke 44 having a substantially U-shaped in cross section is provided. The second yoke 44 is connected to the first yoke 53 and disposed inside the case 10 so as to surround the electromagnet portion 40 together with the first yoke 53.

Next, with reference to FIG. 5, a description will be given of an electromagnetic repulsive force that is generated when the first fixed contact 33a (the second fixed contact 33b) and the first movable contact 34a (the second movable contact 34b ) come into contact and are energized.

As illustrated in FIG. 5, as the movable touch piece 32 is moved upward in the Z direction, the inclined surface of the first fixed contact 33a on the right side in the X direction and the first movable contact 34a come into contact with each other, and the inclined surface of the second fixed contact 33b on the left side in the X direction and the second movable contact 34b come into contact with each other, to be conducted electrically.

At this time, an electromagnetic repulsive force F1 is generated between the first fixed contact 33a and the first movable contact 34a in the direction forming the angle of 01 with respect to the Z direction (the contact or separation direction in which the first movable contact 34a comes into contact with or is separated from the first fixed contact 33a ). Also, at this time, an electromagnetic repulsive force F2 is generated between the second fixed contact 33b and the second movable contact 34b in the direction forming the angle of 02 with respect to the Z direction (the contact or separation direction in which the second movable contact 34b comes into contact with or is separated from the second fixed contact 33b).

Accordingly, an electromagnetic repulsive force acting in the direction (Z direction) in which the first fixed contact 33a and the first movable contact 34a are separated becomes a Z-direction component force of the generated electromagnetic repulsive force F1, and an electromagnetic repulsive force acting in the direction in which the second fixed contact 33b and the second movable contact 34b are separated becomes a Z-direction component force of the generated electromagnetic repulsive force F2. That is, the electromagnetic repulsive force acting in the direction in which the first fixed contact 33a and the first movable contact 34a are separated is reduced, and the electromagnetic repulsive force acting in the direction in which the second fixed contact 33b and the second movable contact 34b are separated is reduced. It is thus possible to ensure the contact reliability between the first fixed contact 33a and the first movable contact 34a and the contact reliability between the second fixed contact 33b and the second movable contact 34b.

The first fixed contact 33a and the first movable contact 34a are provided so as to pass through the center of the movable touch piece 32 and be symmetrical with respect to the movable shaft 35 extending in the Z direction (contact or separation direction). The second fixed contact 33b and the second movable contact 34b are provided so as to pass through the center of the movable touch piece 32 and be symmetrical with respect to the movable shaft 35 extending in the Z direction. For this reason, an X-direction component force of the electromagnetic repulsive force F1, which is generated between the first fixed contact 33a and the first movable contact 34a and an X-direction component force of the electromagnetic repulsive force F2, which is generated between the second fixed contact 33b and the second movable contact 34b are the same magnitude and act in the opposite directions. That is, the X-direction component force being a part of the electromagnetic repulsive force F1 generated between the first fixed contact 33a and the first movable contact 34a is cancelled out by the X-direction component force being a part of the electromagnetic repulsive force F2 generated between the second fixed contact 33b and the second movable contact 34b. This enables improvement in the contact reliability between the first fixed contact 33a and the first movable contact 34a and the contact reliability between the second fixed contact 33b and the second movable contact 34b.

Further, the respective convex curved surfaces of the first contact portion 322 and the second contact portion 323 of the movable touch piece 32 also serve as the first movable contact 34a and the second movable contact 34b. That is, the respective first movable contact 34a and the second movable contact 34b have convex curved surfaces that can come into contact with the first fixed contact 33a and the second fixed contact 33b. This enables the first fixed contact 33a and the first movable contact 34a to come into contact at one point and the second fixed contact 33b and the second movable contact 34b to come into contact at one point, so that the electromagnetic repulsive force can be generated with high accuracy in a desired direction.

### Other Embodiments

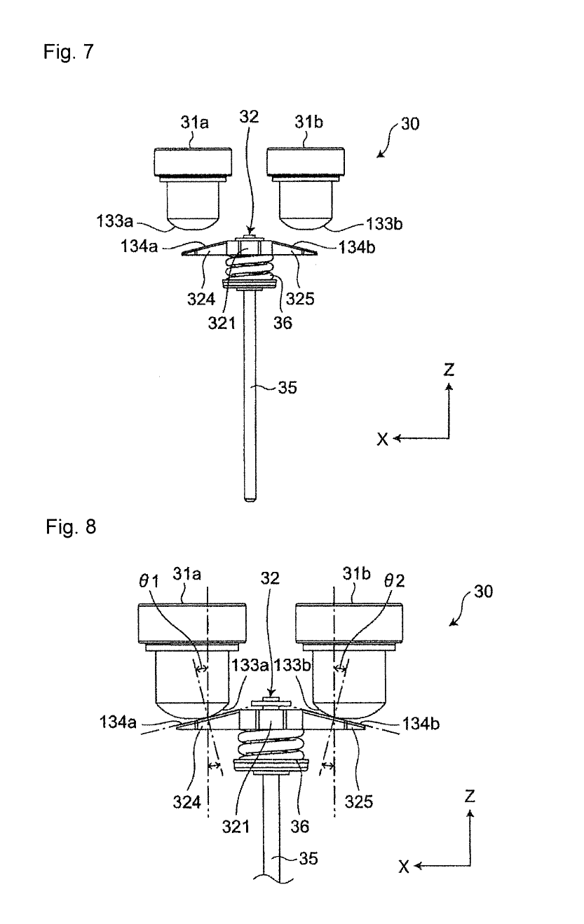

In the above embodiment, each of the first fixed contact 33a and the second fixed contact 33b has the inclined surface, and each of the first movable contact 34a and the second movable contact 34b has the convex curved surface. However, these are not restrictive. For example, as illustrated in FIGS. 6 to 8, each of a first fixed contact 133a and a second fixed contact 133b may have a convex curved surface, and each of a first movable contact 134a and a second movable contact 134b may have an inclined surface.

In this embodiment, the movable touch piece 32 includes a first contact portion 324 and a second contact portion 325 extending from the center portion 321 to both sides in the X direction. On the upper side of each of the first contact portion 324 and the second contact portion 325 in the Z direction, each of the first movable contact 134a and the second movable contact 134b is provided which has an inclined surface inclined downward in the Z direction from the center portion 321.

As described above, even when each of the first fixed contact 133a and the second fixed contact 133b has a convex curved surface that comes into contact with each of the first movable contact 134a and the second movable contact 134b, each of the first fixed contact 133a and the second fixed contact 133b comes into contact with each of the first movable contact 134a and the second movable contact 134b at one point, so that the electromagnetic repulsive force can be generated with high accuracy in a desired direction.

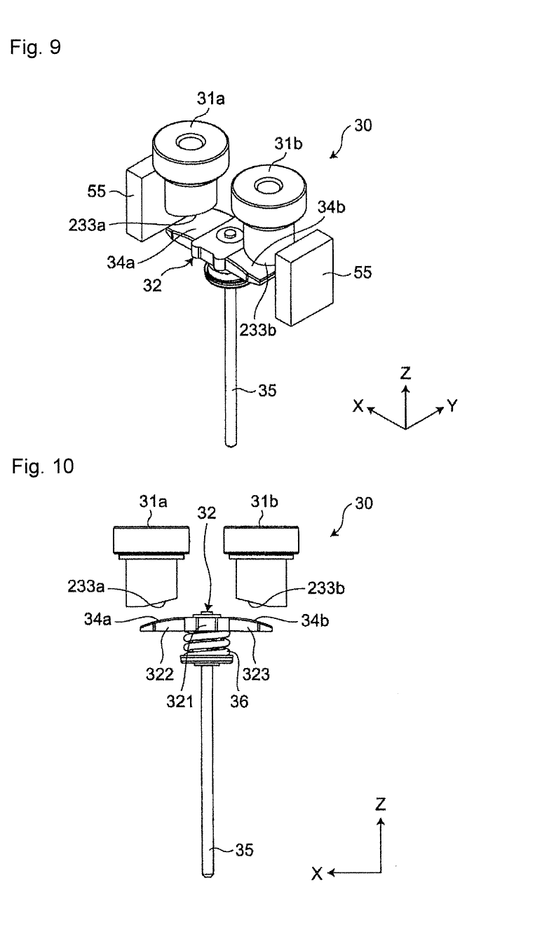

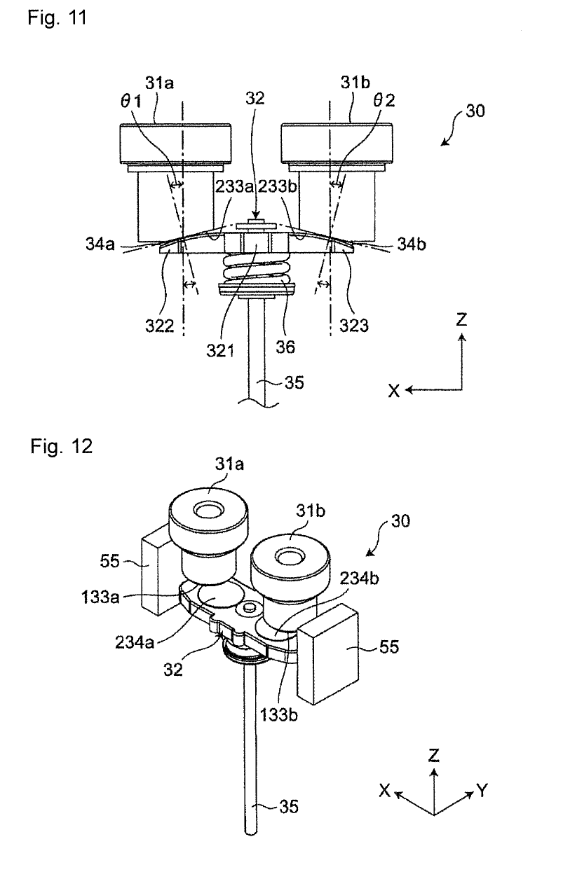

Further, for example, the first fixed contact, the second fixed contact, the first movable contact, and the second movable contact may be a first fixed contact 233a, a second fixed contact 233b, a first movable contact 34a, and a second movable contact 34b illustrated in FIGS. 9 to 11.

In this embodiment, an inclined surface that is inclined upward in the Z direction from the left side toward the right side in the X direction is provided on the lower end face of the first fixed terminal 31a in the Z direction, and the first fixed contact 233a has this inclined surface. Further, an inclined surface that is inclined upward in the Z direction from the right side toward the left side in the X direction is provided on the lower end face of the second fixed terminal 31b in the Z direction, and the second fixed contact 233b has this inclined surface.

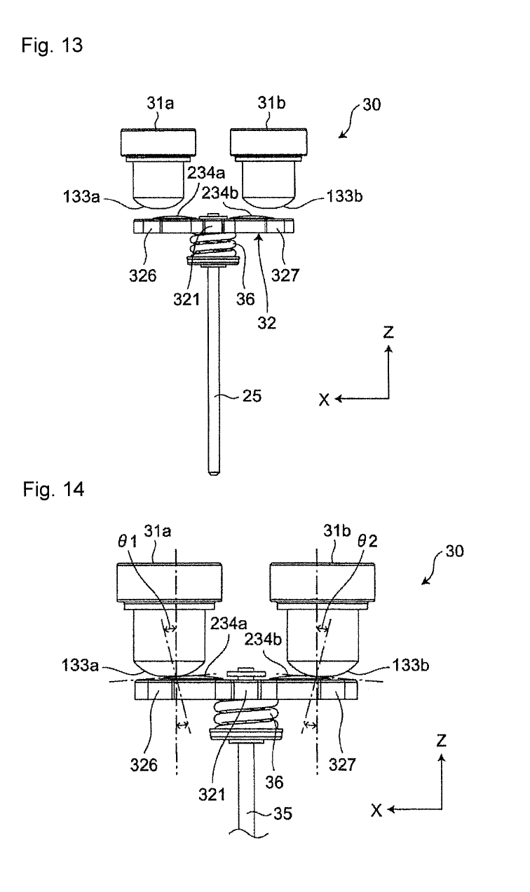

Further, for example, the first fixed contact, the second fixed contact, the first movable contact, and the second movable contact may be a first fixed contact 133a, a second fixed contact 133b, a first movable contact 234a, and a second movable contact 234b illustrated in FIGS. 12 to 14.

In this embodiment, the movable touch piece 32 has a first contact portion 326 and a second contact portion 327 extending from the center portion 321 to both sides in the X direction. The first contact portion 326 and the second contact portion 327 each have the same thickness (in the Z direction) as the center portion 321 and respectively have the first movable contact 234a and the second movable contact 234b provided on the upper surfaces in the Z direction. Each of the first movable contact 234a and the second movable contact 234b has a convex curved surface that slightly bulges toward each of the first fixed contact 133a and the second fixed contact 133b. Each of the first movable contact 234a and the second movable contact 234b is disposed such that the center in the X direction is located closer to the movable shaft 35 than the center of each of the first fixed contact 133a and the second fixed contact 133b is.

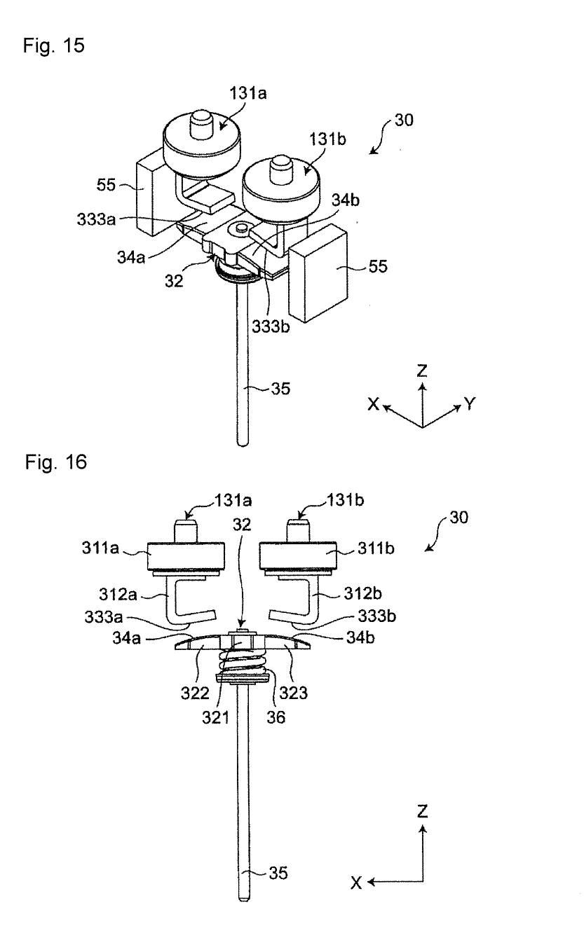

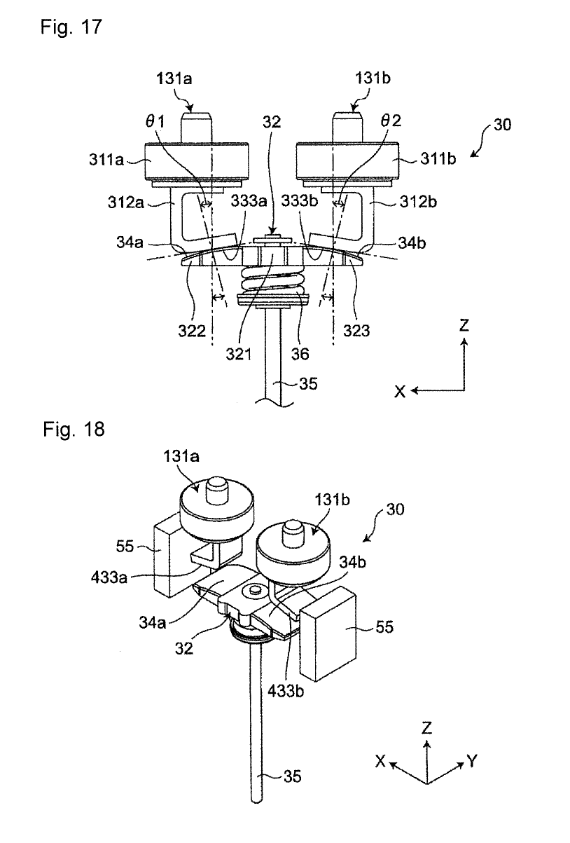

Further, for example, the first fixed contact, the second fixed contact, the first movable contact, and the second movable contact may be a first fixed contact 333a, a second fixed contact 333b, a first movable contact 34a, and a second movable contact 34b illustrated in FIGS. 15 to 17.

In this embodiment, the respective first and second fixed terminals 131a, 131b are made up of guard portions 311a, 311b having a cylindrical shape, contact portions 312a, 312b provided on the lower surfaces of the guard portions 311a, 311b in the Z direction. Each of the contact portions 312a, 312b is made up of a linear portion extending along the Z direction and an inclined portion inclined upward in the Z direction from the lower end of the linear portion in the Z direction toward the movable shaft 35. The first fixed contact 333a is provided on the lower surface of the inclined portion in the Z direction in the contact portion 312a of the first fixed terminal 131a. The second fixed contact 333b is provided on the lower surface of the second linear portion in the Z direction in the contact portion 312b of the second fixed terminal 131b.

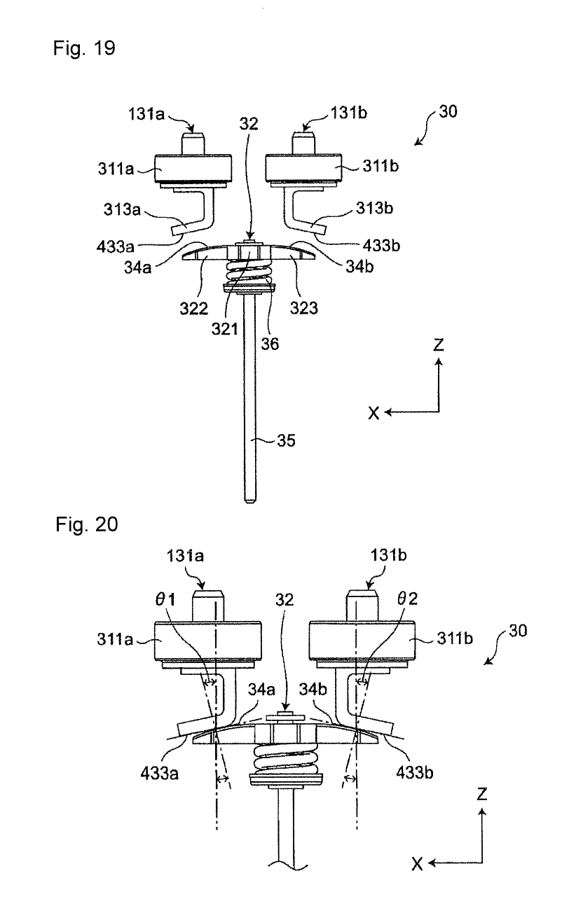

Further, for example, the first fixed contact, the second fixed contact, the first movable contact, and the second movable contact may be a first fixed contact 433a, a second fixed contact 433b, a first movable contact 34a, and a second movable contact 34b illustrated in FIGS. 18 to 20.

In this embodiment, the respective first fixed terminal 131a and second fixed terminal 131b are made up of guard portions 311a, 311b having a cylindrical shape and contact portion 313a, 313b provided on the lower surfaces of the guard portions 311a, 311b in the Z direction. Each of the contact portions 313a, 313b is made up of a linear portion extending along the Z direction and an inclined portion inclined downward in the Z direction from the lower end of the linear portion in the Z direction in a direction away from the movable shaft 35. The first fixed contact 433a is provided on the lower surface of the inclined portion in the Z direction in the contact portion 313a of the first fixed terminal 131a. The second fixed contact 433b is provided on the lower surface of the second linear portion in the Z direction in the contact portion 313b of the second fixed terminal 131b.

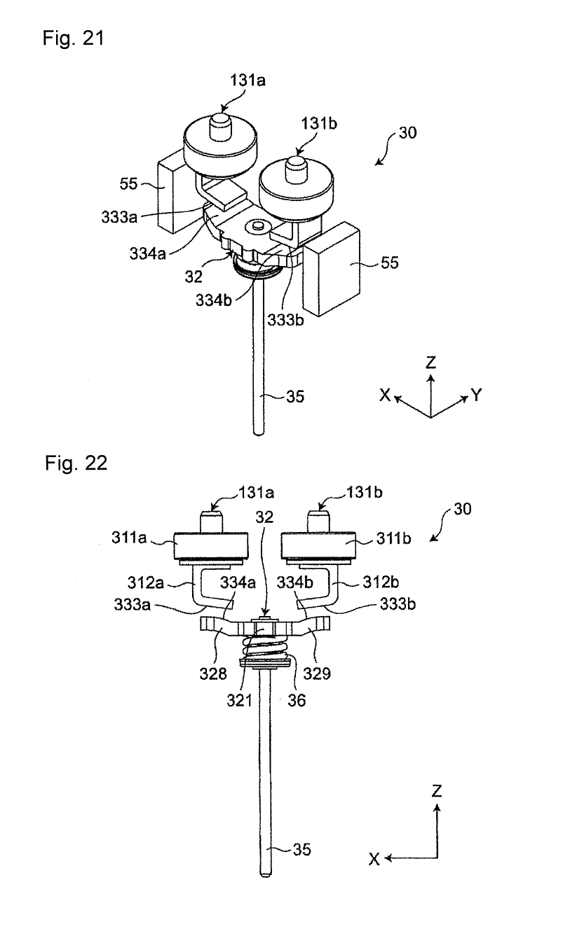

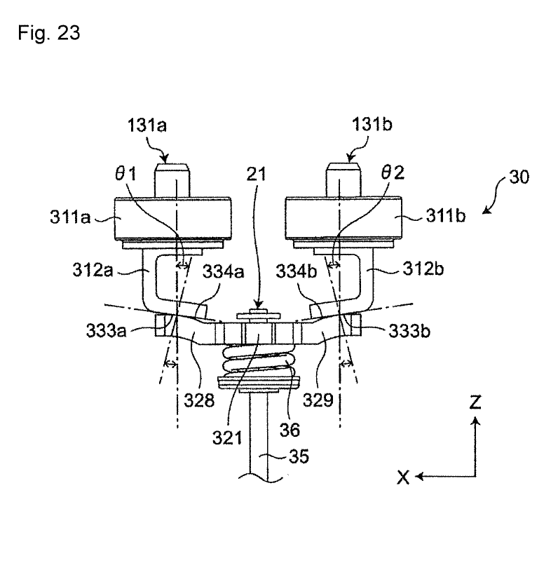

Further, for example, the first fixed contact, the second fixed contact, the first movable contact, and the second movable contact may be a first fixed contact 333a, a second fixed contact 333b, a first movable contact 334a, and a second movable contact 334b illustrated in FIGS. 21 to 23.

In this embodiment, the movable touch piece 32 has a first contact portion 328 and a second contact portion 329 extending from the center portion 321 to both sides in the X direction. The first contact portion 328 has a convex curved surface on the upper side in the Z direction. The convex curved surface of the first contact portion 328 is curved upward in the Z direction toward the left side in the X direction. The first movable contact 334a is provided on the convex curved surface of the first contact portion 328. The second contact portion 329 has a convex curved surface on the upper side in the Z direction. The convex curved surface of the second contact portion 329 is curved upward in the Z direction toward the right side in the X direction. The second movable contact 334b is provided on the convex curved surface of the second contact portion 329.

In this manner, the first fixed contact, the second fixed contact, the first movable contact, and the second movable contact are oriented so as to face each other in the direction intersecting with the direction in which the first fixed contact (second fixed contact) comes into contact with or is separated from the first fixed contact (second fixed contact). Therefore, a freely selected configuration can be formed so long as an electromagnetic repulsive force generated at the time of energization is generated in the direction intersecting with the direction in which the first movable contact (second movable contact) comes into contact with or is separated from the first fixed contact (second fixed contact).

For example, the angle θ1 and the angle θ2 may be the same or different, the angle θ1 being formed by the direction of the electromagnetic repulsive force generated between the first fixed contact and the first movable contact and the contact or separation direction of the first movable contact, the angle θ2 being formed by the direction of the electromagnetic repulsive force generated between the second fixed contact and the second movable contact and the contact or separation direction of the second movable contact.

The first fixed contact 33a and the first movable contact 34a may be disposed asymmetrically with respect to the movable shaft 35. The second fixed contact 33b and the second movable contact 34b may be disposed asymmetrically with respect to the movable shaft 35.

The contact or separation direction of the first movable contact 34a and the contact or separation direction of the second movable contact 34b may be the same direction or different directions.

Naturally, the constituents described in the above embodiments may be appropriately combined, or may be appropriately selected, replaced, or deleted.

Below, various embodiments of the present invention will be described.

A contact mechanism according to one or more embodiments of the present invention includes: first and second fixed contacts; and first and second movable contacts that respectively face the first and second fixed contacts and are movable in a contact or separation direction in which the first and second movable contacts respectively come into contact with or are separated from the first and second fixed contacts. The first fixed contact and the first movable contact are disposed so as to face each other in a direction intersecting with the contact or separation direction. The second fixed contact and the second movable contact are disposed so as to face each other in the direction intersecting with the contact or separation direction.

A contact mechanism according to one or more embodiments of the present invention includes: the first fixed contact and the second fixed contact; and the first movable contact and the second movable contact that respectively face the first fixed contact and the second fixed contact, and are disposed so as to respectively come into contact with or be separated from the first fixed contact and the second fixed contact. The first fixed contact and the first movable contact are disposed so as to face each other in a direction intersecting with the contact or separation direction in which the first movable contact and the second movable contact come into contact with or are separated from the first fixed contact and the second fixed contact. The second fixed contact and the second movable contact are disposed so as to face each other in the direction intersecting with the contact or separation direction.

Accordingly, when the fixed contact and the movable contact come into contact with each other and are energized, an electromagnetic repulsive force is generated in a direction intersecting with the direction in which the fixed contact and the movable contact come into contact with or are separated from each other. Therefore, the electromagnetic repulsive force acting in the direction in which the fixed contact and the movable contact are separated is reduced, and the contact reliability between the fixed contact and the movable contact can be ensured.

A contact mechanism according to one or more embodiments of the present invention further includes a movable touch piece electrically connecting the first and second movable contacts. The first and second fixed contacts and the first and second movable contacts are provided so as to be symmetrical with respect to a straight line passing through a center of the movable touch piece and extending in the contact or separation direction.

A contact mechanism according to one or more embodiments of the present invention further includes the movable touch piece electrically connecting the first movable contact and the second movable contact. The first fixed contact and the second fixed contact are disposed so as to be symmetrical with respect to a straight line passing through the center of the movable touch piece and extending in the contact or separation direction. The first movable contact and the second movable contact are disposed so as to be symmetrical with respect to the straight line passing through the center of the movable touch piece and extending in the contact or separation direction

Accordingly, a part of the electromagnetic repulsive force generated between the first fixed contact and the first movable contact is canceled out by the electromagnetic relay generated between the second fixed contact and the second movable contact. This enables improvement in the contact reliability between the first fixed contact and the first movable contact and the contact reliability between the second fixed contact and the second movable contact.

In a contact mechanism according to one or more embodiments of the present invention, each of the first and second movable contacts has a convex curved surface that comes into contact with each of the first and second fixed contacts.

In a contact mechanism according to one or more embodiments of the present invention, each of the first movable contact and the second movable contact has a convex curved surface capable of coming into contact with each of the first fixed contact and the second fixed contact.

According to a contact mechanism according to one or more embodiments of the present invention, the first fixed contact and the first movable contact come into contact with each other at one point and the second fixed contact and the second movable contact come into contact with each other at one point, so that the electromagnetic repulsive force can be generated with high accuracy in a desired direction.

In a contact mechanism according to one or more embodiments of the present invention, each of the first and second fixed contacts has a convex curved surface that comes into contact with each of the first and second movable contacts.

In a contact mechanism according to one or more embodiments of the present invention, each of the first fixed contact and the second fixed contact has the convex curved surface capable of coming into contact with each of the first movable contact and the second movable contact.

Accordingly, the first fixed contact and the first movable contact come into contact with each other at one point and the second fixed contact and the second movable contact come into contact with each other at one point, so that the electromagnetic repulsive force can be generated with high accuracy in a desired direction

An electromagnetic relay according to one or more embodiments of the present invention includes one or more of the above contact mechanisms described.

Accordingly, the contact mechanism according to one or more embodiments of the present invention ensures contact reliability between the fixed contact and the movable contact.

By appropriately combining freely selected embodiments or modifications of the above variety of embodiments and modifications, it is possible to achieve the respective effects of those combined. It is possible to combine embodiments, combine examples, or combine an embodiment and an example, and also possible to combine features in different embodiments or examples.

While the present invention has been fully described in connection with embodiments with reference to the accompanying drawings, a variety of modified examples or corrections will be apparent to those skilled in the art. Such modifications or amendments are to be understood as being included in the scope of the invention according to the appended claims so long as not deviating therefrom.

A contact mechanism and an electromagnetic relay of the present invention are not limited to the above embodiments and can be applied to other electromagnetic relays.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### DESCRIPTION OF SYMBOLS

1 housing

10 case

11 terminal groove

12 latching hole

20 cover

21 partition wall

22 terminal hole

30 contact mechanism portion

31 fixed terminal

32 movable touch piece

321 center portion

322, 324, 326, 328 first contact portion

323, 325, 327, 329 second contact portion

33a, 133a, 133a, 233a, 333a, 433a first fixed contact

33b, 133b, 133b, 233b, 333b, 433b second fixed contact

34a, 134a, 234a, 334a first movable contact

34b, 134b, 234b, 334b second movable contact

35 movable shaft

36 coil spring

40 electromagnet portion

41 spool

411 body portion

412 guard portion

42 coil

43 coil terminal

44 second yoke

51 flange

52 ceramic plate

521 terminal hole

53 first yoke

531 opening

54 bottomed cylindrical body

55 permanent magnet

56 magnet holder

57 fixed iron core

58 movable iron core

59 return spring

61 arc shielding member

100 electromagnetic relay

F1 electromagnetic repulsive force generated between first fixed contact and first movable contact

F2 electromagnetic repulsive force generated between second fixed contact and second movable contact

1. A contact mechanism comprising:
a first fixed contact;
a second fixed contact;
a first movable contact that faces the first fixed contact, and that is disposed so as to come into contact with or be separated from the first fixed contact; and
a second movable contact that faces the second fixed contact, and that is disposed so as to come into contact with or be separated from the second fixed contact,
wherein the first fixed contact and the first movable contact are disposed so as to face each other in a direction intersecting with a contact-separation direction in which the first movable contact and the second movable contact come into contact with or are separated from the first fixed contact and the second fixed contact, and
wherein the second fixed contact and the second movable contact are disposed so as to face each other in the direction intersecting with the contact-separation direction.

2. The contact mechanism according to claim 1, wherein each of the first movable contact and the second movable contact has a convex curved surface that come into contact with each of the first fixed contact and the second fixed contact.

3. The contact mechanism according to claim 1, wherein each of the first fixed contact and the second fixed contact has a convex curved surface that come into contact with the first movable contact and the second movable contact.

4. The contact mechanism according to claim 1, further comprising:
a movable touch piece electrically connecting the first movable contact and the second movable contact,
wherein the first fixed contact and the second fixed contact are disposed so as to be symmetrical with respect to a straight line passing through a center of the movable touch piece and extending in the contact-separation direction, and
wherein the first movable contact and the second movable contact are disposed so as to be symmetrical with respect to the straight line passing through the center of the movable touch piece and extending in the contact-separation direction.

5. An electromagnetic relay comprising:
the contact mechanism according to claim 1.

6. The contact mechanism according to claim 2, wherein each of the first fixed contact and the second fixed contact has a convex curved surface that come into contact with the first movable contact and the second movable contact.

7. The contact mechanism according to claim 2, further comprising:
a movable touch piece electrically connecting the first movable contact and the second movable contact,
wherein the first fixed contact and the second fixed contact are disposed so as to be symmetrical with respect to a straight line passing through a center of the movable touch piece and extending in the contact-separation direction, and
wherein the first movable contact and the second movable contact are disposed so as to be symmetrical with respect to the straight line passing through the center of the movable touch piece and extending in the contact-separation direction.

8. The contact mechanism according to claim 3, further comprising:
a movable touch piece electrically connecting the first movable contact and the second movable contact,
wherein the first fixed contact and the second fixed contact are disposed so as to be symmetrical with respect to a straight line passing through a center of the movable touch piece and extending in the contact-separation direction, and
wherein the first movable contact and the second movable contact are disposed so as to be symmetrical with respect to the straight line passing through the center of the movable touch piece and extending in the contact-separation direction.

9. An electromagnetic relay comprising:
the contact mechanism according to claim 2.

10. An electromagnetic relay comprising:
the contact mechanism according to claim 3.

11. An electromagnetic relay comprising:
the contact mechanism according to claim 4.
